(19) United States
(12) Patent Application Publication
(10) Pub. No.: US 2007/0174282 A1
(43) Pub. Date: Jul. 26, 2007

(54) Access control method, access control apparatus, and computer product

(75) Inventors: Yuichi Matsuda, Kawasaki (JP); Takao Mohri, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/412,780

(22) Filed: Apr. 28, 2006

(30) Foreign Application Priority Data
Jan. 11, 2006 (JP) 2006-004098

(51) Int. Cl. G06F 17/30

(52) U.S. Cl. 707/9

(57) ABSTRACT

When a service apparatus receives a service request from a client apparatus, the service apparatus determines an access propriety based on whether the client apparatus is already registered in a list. If the client apparatus is not registered, the service apparatus acquires meta-information of the client apparatus in question and also other apparatuses. The service apparatus then determines an approving apparatus among the apparatuses based on the acquired meta-information. The approving apparatus is made to display the meta-information of the client apparatus in question and requests an approver to judge propriety of service provision.

### BACKGROUND OF THE INVENTION

1. Field of the Invention

The present invention relates to access control programs, access control methods, and access control apparatuses for controlling access to a service in response to a service provision request from a client apparatus connected via a network, and, more particularly to access control programs, access control methods, and access control apparatuses for providing, in access control in an ad-hoc environment, an access approver with information useful for determining propriety of approval to allow the approver to make an appropriate judgment.

2. Description of the Related Technology

According to the spread of information apparatuses like personal computers and personal digital electronics, it is expected that people will more often use apparatuses in places where the people visit rather than carrying all apparatuses necessary for work. Universal Plug & Play (UPnP) attracts attention as one of apparatus finding and cooperation protocols for such use of apparatuses.

The UPnP is a protocol for easily using an apparatus in a place where the apparatus is found through a network. The UPnP is standardized in the UPnP Forum. Concerning the UPnP, standards for mutually connecting a home router and AV apparatuses (a video, a television, a personal computer, etc.) are spread. At present, the UPnP is mainly used at home. However, it is expected that the UPnP will be used not only at home but also in various places like offices and the Intelligent Transport System (ITS).

What is required in that case is a security function like authentication or access control. The house where the present UPnP is mainly used is a safe space that is guarded against intruders. Thus, it may be considered that security check is performed to some extent at a point when a resident enters the house and connects his/her apparatus to a home Local Area Network (LAN). Therefore, at home, importance of the security function is considered to be relatively low.

However, when a range of applications of the UPnP is expanded, for example, from offices to the ITS and mobile communication in future, security will be important. For example, when a UPnP apparatus is connected to a LAN in an office, it is likely that a large number of apparatuses access a large-scale in-house network. Since the ITS and the mobile devices operate outdoor, it is likely that suspicious terminals like terminals of other people access the ITS and the mobile devices. Therefore, measures against such access are required.

Assuming that a user finds an apparatus at a destination and desires to use the apparatus immediately, functions different from those in the past are required for authentication at the time of access to the apparatus. For example, when participants in a meeting connect their notebook PCs or portable terminals to a network at a conference room where the participants are in the meeting or immediately use a printer and a projector provided in the conference room, authentication and access control functions of a type for checking access from the apparatuses and allowing the access are required. Authentication and access control of such a type is called access control in an ad-hoc environment.

Requirements in realizing the access control in an ad-hoc environment are as described below.

(1) Authentication and Access Control is Supported without Pre-Registration

Even if a user does not register a user name, a password, an apparatus name, an address, and the like in advance, authentication and access control for an accessing apparatus is supported according to a judgment by an approver.

(2) Information Required for Access Approval is Presented to be Easily Understood by the Approver

Information required for access approval is presented to be easily understood by the approver to reduce burdens of judgment by the approver and support assurance of security.

(3) Interconnectivity with Existing UPnP Apparatuses and Services are Assured

It is possible to set existing UPnP apparatuses and services as objects of authentication and access control without altering the UPnP apparatuses and services. It is necessary to set programs created in UPnP libraries of other companies as objects in the same manner.

As a conventional technology responding to such a request, there is a method of providing an approver with an IP address (a host name) of an accessing client, specifically, a UPnP control point and requesting the approver to judge propriety of access (see, for example, “DiXim-Multimedia Home Network Solution”, retrieved on Dec. 17, 2005, Internet <URL: HYPERLINK http://www.microsoft.com/japan/enable/training/kblight/t004 /7/01.htm http://www.dixim.net/>).

FIG. 15 is a diagram of an example of a dialog window for urging an approver to judge propriety of access. As shown in the figure, in this example, when there is an accessing client, an IP address (a host name) of the client is displayed in a popup window to request the approver to judge whether the access should be approved.

However, in such a conventional technology, since only an IP address (a host name) of an accessing apparatus is displayed as information of the apparatus, it is difficult for the approver to distinguish the accessing apparatus from other apparatuses. Thus, the approver cannot perform an accurate judgment on propriety of access. In particular, when IP addresses are dynamically allocated by a Dynamic Host Configuration Protocol (DHCP), it is difficult to specify an apparatus or judge propriety of connection only from an IP address or a host name.

A window for requesting approval is displayed on an accessed apparatus. Thus, the approver is required to be capable of immediately approving the access in front of the accessed apparatus. However, for example, when an apparatus on the second floor is accessed from the first floor in the house, the approver is not always in front of the apparatus. Therefore, when the window for requesting approval is always displayed on the accessed apparatus, this is inconvenient for the approver.

### SUMMARY OF THE INVENTION

It is an object of the present invention to at least partially solve the problems in the conventional technology.

According to an aspect of the present invention, an access control method of controlling access to a service in response to a service provision request from a client apparatus connected to the access control apparatus via a network, includes first acquiring including acquiring requesting apparatus meta-information that is meta-information of the client apparatus; providing an apparatus used by an approver of access to the service for approval with the requiring apparatus meta-information acquired at the acquiring and second acquiring including acquiring access propriety that is received by the apparatus from the approver by providing the approver with the requesting apparatus meta-information; and controlling access to the service based on the access propriety acquired at the second acquiring.

According to another aspect of the present invention, an access control apparatus that controls access to a service in response to a service provision request from a client apparatus connected to the access control apparatus via a network, includes a meta-information acquiring unit that acquires requesting apparatus meta-information that is meta-information of the client apparatus; an access propriety acquiring unit that provides an apparatus used by an approver of access to the service for approval with the requiring apparatus meta-information acquired by the meta-information acquiring unit and acquires access propriety that is received by the apparatus from the approver by providing the approver with the requesting apparatus meta-information; and a service provision control unit that controls access to the service based on the access propriety acquired by the access propriety acquiring unit.

According to still another aspect of the present invention, a computer-readable recording medium stores therein a computer program that implements the above method according to the present invention on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of a system configuration of an access control system according to an embodiment of the present invention;

FIG. 2 is a diagram of an example of construction of an access control system;

FIG. 3A is a table of an example of meta-information managed by a meta-information managing unit of a client apparatus;

FIG. 3B is a table of an example of meta-information managed by a meta-information managing unit of a service apparatus;

FIG. 3C is a table of an example of meta-information managed by a meta-information managing unit of an approving apparatus;

FIG. 4 is a table of an example of an Access Control List (ACL) managed by an ACL managing unit;

FIG. 5 is a diagram of an example of an approval request screen outputted by the approving apparatus;

FIG. 6 is a flowchart of a processing procedure of an access mediating unit;

FIG. 7 is a flowchart of a processing procedure of an access control unit;

FIG. 8 is a flowchart of a processing procedure of meta-information acquisition processing;

FIG. 9 is a flowchart of a processing procedure of approval request processing;

FIG. 10 is a flowchart of a processing procedure of the ACL managing unit;

FIG. 11 is a flowchart of a processing procedure of the meta-information managing unit;

FIG. 12 is a flowchart of a processing procedure of an approving unit;

FIG. 13 is a diagram of an operation sequence of an access control system according to the embodiment;

FIG. 14 is a functional block diagram of a constitution of a computer that executes an access control program according to the embodiment; and

FIG. 15 is a diagram of an example of a dialog window that urges an approver to judge propriety of access.

### DETAILED DESCRIPTION OF THE PREFERRED EMBODIMENTS

Exemplary embodiments of the present invention are explained in detail below with reference to the accompanying drawings. The embodiments are explaining below using a network in which it is possible to use the UPnP.

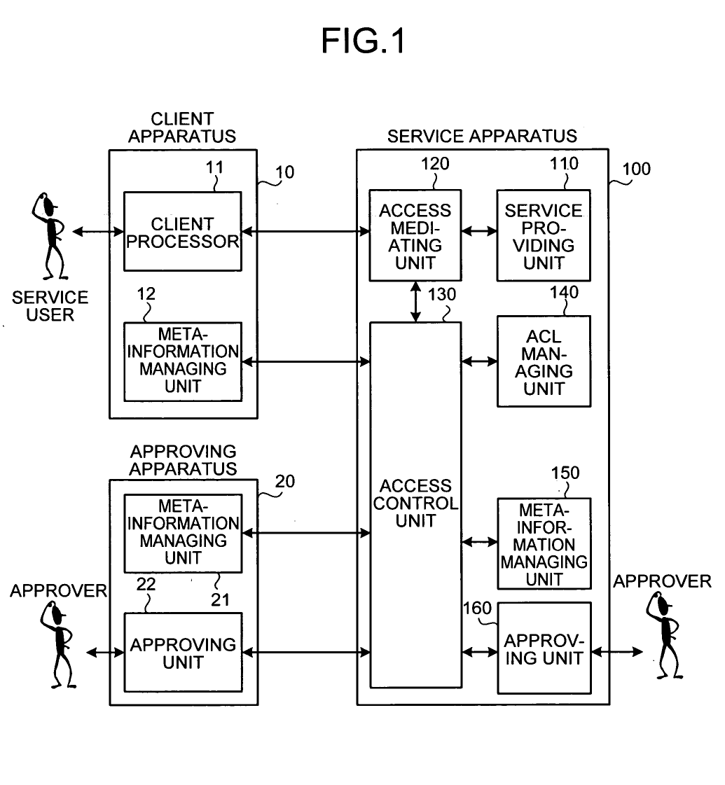

A constitution of an access control system according to an embodiment of the present invention is explained. FIG. 1 is a diagram of a system configuration of the access control system according to the embodiment. As shown in the figure, in the access control system, a service apparatus 100 that provides a service, a client apparatus 10 that requests a service, and an approving apparatus 20 that an approver uses for approval are connected via a network in which it is possible to use the UPnP.

For convenience of explanation, only one client apparatus 100 is shown. However, a plurality of client terminals can be connected to the access control system. Since approval of access may be performed by the service apparatus 100, the approving apparatus 20 does not have to be provided in the system.

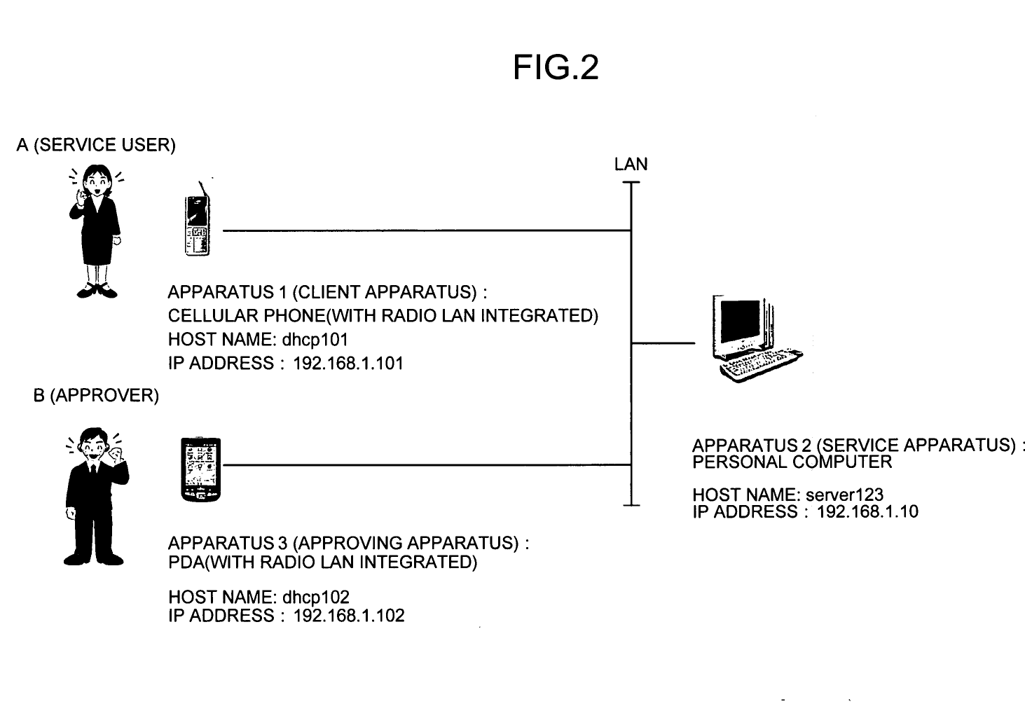

FIG. 2 is a diagram of an example of construction of an access control system. As shown in the figure, in this access control system, a radio LAN integrated cellular phone serving as a client apparatus, a personal computer serving as a service apparatus, and a radio LAN integrated Personal Digital Assistant (PDA) are connected to a LAN. When an owner “A” of the cellular phone requests access to the personal computer, an approval request is displayed on the PDA owned by an approver “B” and access to the personal computer of “A” is controlled based on determination of “B”.

Referring back to FIG. 1, the client apparatus 10 has a client processor 11 and a meta-information managing unit 12. The client processor 11 is a processor that performs processing as a control point of the UPnP. The client processor 11 requests a service of the service apparatus 100 according to an instruction of a service user. In other words, the client processor 11 requests access to the service apparatus 100.

The meta-information managing unit 12 is a managing unit that manages meta-information concerning an apparatus that makes connection to the network. The meta-information managing unit 12 provides a meta-information management function. The meta-information managing unit 12 notifies presence of the meta-information management function and provides meta-information in response to inquiries from other apparatuses.

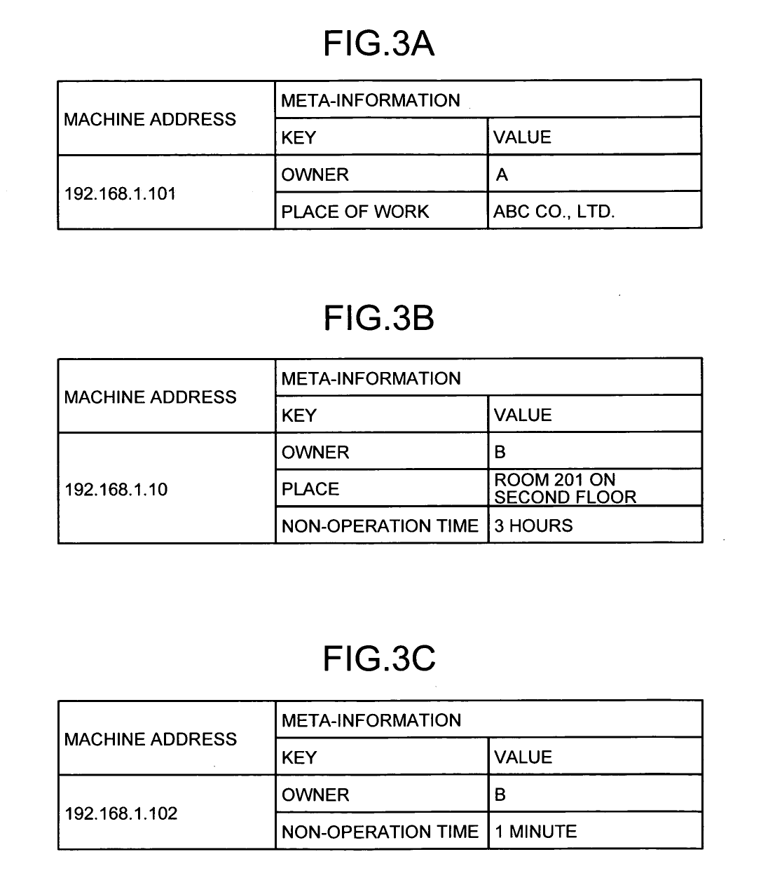

FIG. 3A is a table of an example of meta-information managed by the meta-information managing unit 12. As shown in the figure, in this example, the meta-information managing unit 12 manages information on an owner and a place of work of the owner as well as a machine address (an IP address) as meta-information concerning the client apparatus 10.

In the service apparatus 100 and the approving apparatus 20, meta-information managing units manage meta-information in the same manner. FIG. 3B is a table of an example of meta-information managed by a meta-information managing unit 150 of the service apparatus 100. As shown in the figure, in this example, the meta-information managing unit 150 manages information on an owner, a place and, a non-operation time as meta-information concerning the service apparatus 100. The non-operation time is time during which the service apparatus 100 is not operated by a user. A value of the non-operation time is periodically updated by monitoring operation of a mouse and a keyboard.

FIG. 3C is a diagram of an example of meta-information managed by a meta-information managing unit 21 of the approving apparatus 20. As shown in the figure, in this example, the meta-information managing unit 21 manages information on an owner and a non-operation time as meta-information concerning the approving apparatus 20.

In the examples shown in FIGS. 3A to 3C, only the pieces of meta-information concerning the client apparatus 10, the service apparatus 100, and the approving apparatus 20 are shown as examples of meta-information managed by the meta-information managing units of the respective apparatuses. However, the respective meta-information managing units can also manage meta-information concerning other apparatuses connected to the network.

Referring back to FIG. 1, the service apparatus 100 includes a service providing unit 110, an access mediating unit 120, an access control unit 130, an ACL managing unit 140, the meta-information managing unit 150, and an approving unit 160.

The service providing unit 110 is a processor that provides a service requested by the client apparatus 10. However, the service providing unit 110 not only directly provides the client apparatus 10 with a service but also provides the client apparatus 10 with a service via the access mediating unit 120.

The access mediating unit 120 is a processor that receives a service request from the client apparatus 10, inquires the access control unit 130 about propriety of access, and, when access is permitted, mediates between the client apparatus 10 and the service providing unit 110.

The access control unit 130 is a processor that judges whether access should be permitted in response to a service request from the client apparatus 10. Specifically, the access control unit 130 inquires the ACL managing unit 140 whether information on propriety of access of the client apparatus 10 is registered. When the information is registered, the access control unit 130 sends content of the registration to the access mediating unit 120 as a reply.

On the other hand, when the information is not registered, the access control unit 130 collects meta-information of the client apparatus 10 and also collects meta-information of the other apparatuses connected to the network. The access control unit 130 determines, based on the meta-information, specifically, information on an owner and a non-operation time, an apparatus that requests approval.

The access control unit 130 transmits the meta-information of the client apparatus 10 and the meta-information of the service apparatus 100, specifically, an owner of the client apparatus 10 and a place of work of the owner to the apparatus that requests approval and requests the apparatus to judge propriety of access. The access control unit 130 receives a judgment result of the approver, instructs the ACL managing unit 140 to register the judgment result, and sends the judgment result to the access mediating unit 120 as a reply.

The access control unit 130 collects meta-information of the apparatuses connected to the network and determines, based on the meta-information, specifically, information on an owner and a non-operation time, an apparatus that requests approval. Consequently, the access control unit 130 can send an approval request to an apparatus convenient for the approver. In this embodiment, it is assumed that the approving apparatus 20 is determined as the apparatus that requests approval.

When the information on propriety of access of the client apparatus 10 is not registered, the access control unit 130 collects meta-information of the client apparatus 10, provides the approver with the meta-information collected, specifically, the information on an owner of the client apparatus 10 and a place of work of the owner, and requests the approver to judge propriety of access. Consequently, the approver can appropriately make a judgment on propriety of access.

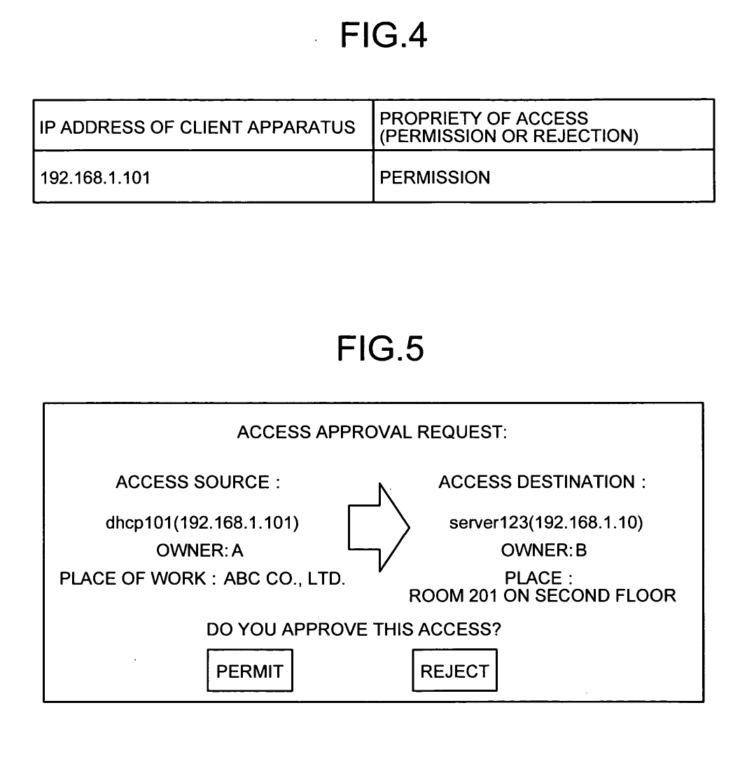

The ACL managing unit 140 is a managing unit that manages information on propriety of access of the client apparatus 10 as an Access Control List (ACL). FIG. 4 is a table of an example of the ACL managed by the ACL managing unit 140. As shown in the figure, this ACL is information in which an IP address and propriety of access are associated for each client apparatus 10.

The meta-information managing unit 150 is a managing unit that manages the meta-information shown in FIG. 3B. The meta-information managing unit 150 notifies presence of the meta-information management function and provides meta-information in response to inquiries from the other apparatuses. In other words, the meta-information managing unit 150 provides the meta-information management function.

The approving unit 160 is a processor that displays an approval request screen for the approver of service provision and requests the approver to judge propriety of access. The approving unit 160 receives a judgment of the approver and sends the judgment to the access control unit 130 as a reply. In other words, the approving unit 160 provides an approval function. In this embodiment, since the approving apparatus 20 is selected as the apparatus that requests the approver to approve service provision, an instruction is not given to the approving unit 160 from the access control unit 130.

The approving apparatus 20 includes a meta-information managing unit 21 and an approving unit 22. The meta-information managing unit 21 is a managing unit that manages the meta-information shown in FIG. 3C. The meta-information managing unit 21 notifies presence of the meta-information management function and provides meta-information in response to inquiries from the other apparatuses. In other words, the meta-information managing unit 21 provides the meta-information management function.

The approving unit 22 is a processor that displays an approval request screen for the approver of service provision and requests the approver to judge propriety of access based on an instruction from the access control unit 130. The approving unit 22 receives a judgment of the approver and sends the judgment to the access control unit 130 as a reply. In other words, the approving unit 22 provides an approval function.

FIG. 5 is a diagram of an example of an approval request screen outputted by the approving apparatus 20. As shown in the figure, an owner of an apparatus and a place of work of the owner as well as a host name and an IP address are displayed on this approval request screen as information on an access source. An owner of an apparatus and a place of work of the owner as well as a host name and an IP address are displayed on the approval request screen as information on an access destination. The approver can accurately judge propriety of access by displaying the owner of the apparatus at the access source and the place of work of the owner on the approval request screen.

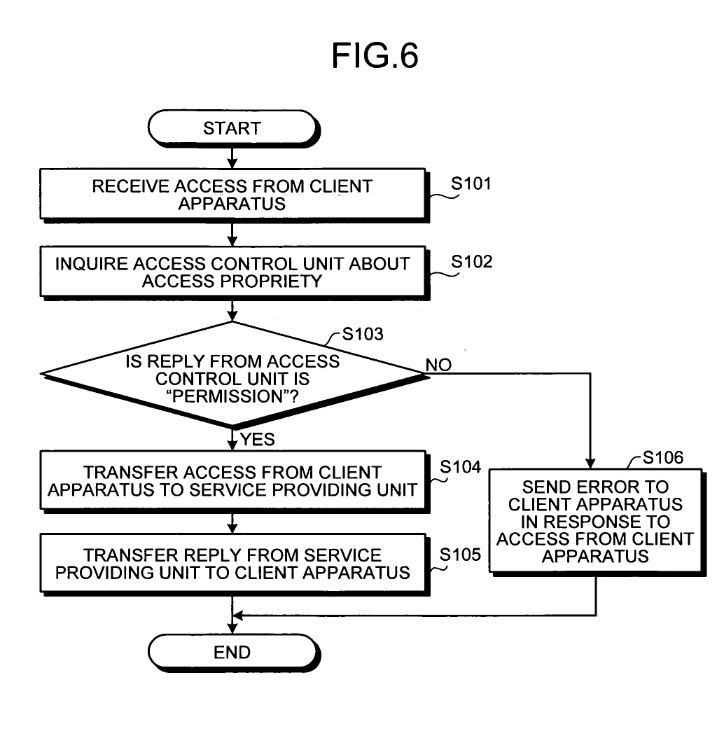

A processing procedure of the access mediating unit 120 is explained. FIG. 6 is a flowchart of the processing procedure of the access mediating unit 120. As shown in the figure, when the access mediating unit 120 waits for access from the client apparatus 10 and receives access (step S101), the access mediating unit 120 inquires the access control unit 130 about propriety of access (step S102).

When a reply from the access control unit 130 is “permission” (“Yes” at step S103), the access mediating unit 120 transfer the access from the client apparatus 10 to the service providing unit 110 (step S104) and transfers a reply from the service providing unit 110 to the client apparatus 10 (step S105).

On the other hand, when a reply from the access control unit 130 is not “permission” (“No” at step S103), the access mediating unit 120 sends an error to the client apparatus 10 in response to the access from the client apparatus 10 (step S106).

In this way, the access mediating unit 120 inquires the access control unit 130 about propriety of access and, only when a reply from the access control unit 130 is “permission”, mediates between the client apparatus 10 and the service providing unit 110. Consequently, the access mediating unit 120 can appropriately control the access from the client apparatus 10.

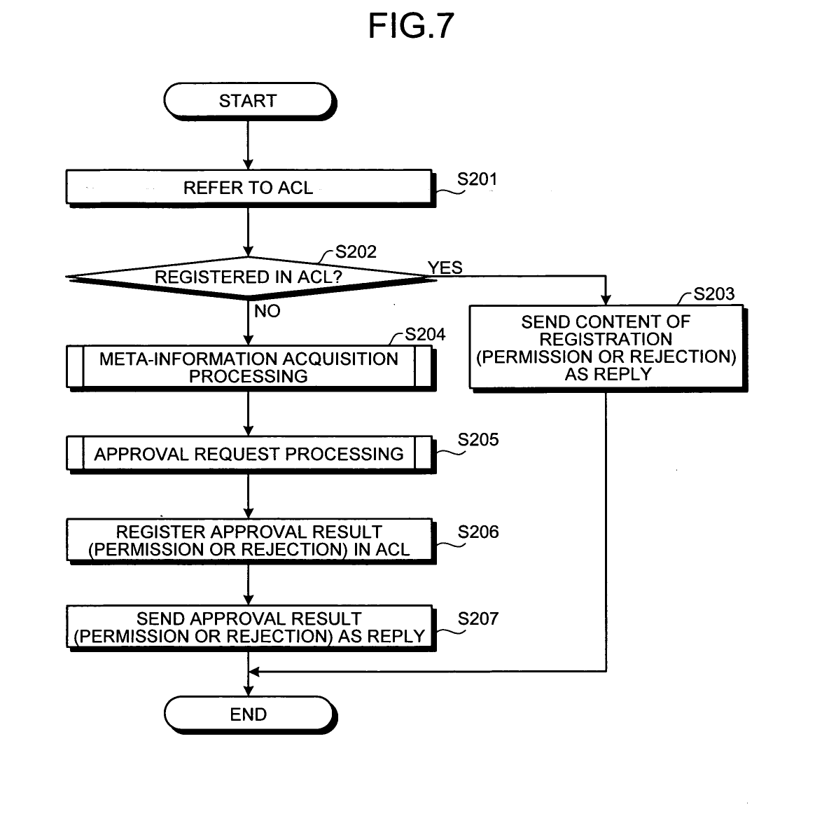

A processing procedure of the access control unit 130 is explained. FIG. 7 is a flowchart of the processing procedure of the access control unit 130. As shown in the figure, when the access control unit 130 receives an inquiry about propriety of access from the access mediating unit 120, first, the access control unit 130 requests the ACL managing unit 140 to refer to an ACL (step S201) and judges whether the client apparatus 10 is registered in the ACL (step S202). As a result, when the client apparatus 10 is registered in the ACL, the access control unit 130 sends content of the registration to the access mediating unit 120 as a reply (step S203).

On the other hand, when the client apparatus 10 requesting access is not registered in the ACL, the access control unit 130 performs meta-information acquisition processing for acquiring meta-information of the client apparatus 10 (step S204) and performs approval request processing for providing the approver with the meta-information acquired and requesting the approver to judge propriety of approval (step S205).

The access control unit 130 instructs the ACL managing unit 140 to register an approval result (permission or rejection) of the approver in the ACL (step S206) and sends the approval result to the access mediating unit 120 as a reply (step S207).

In this way, the access control unit 130 performs the meta-information acquisition processing for acquiring meta-information of the client apparatus 10 and performs the approval request processing for providing the approver with the meta-information acquired and requesting the approver to judge propriety of approval. Consequently, the approver can appropriately judge propriety of approval.

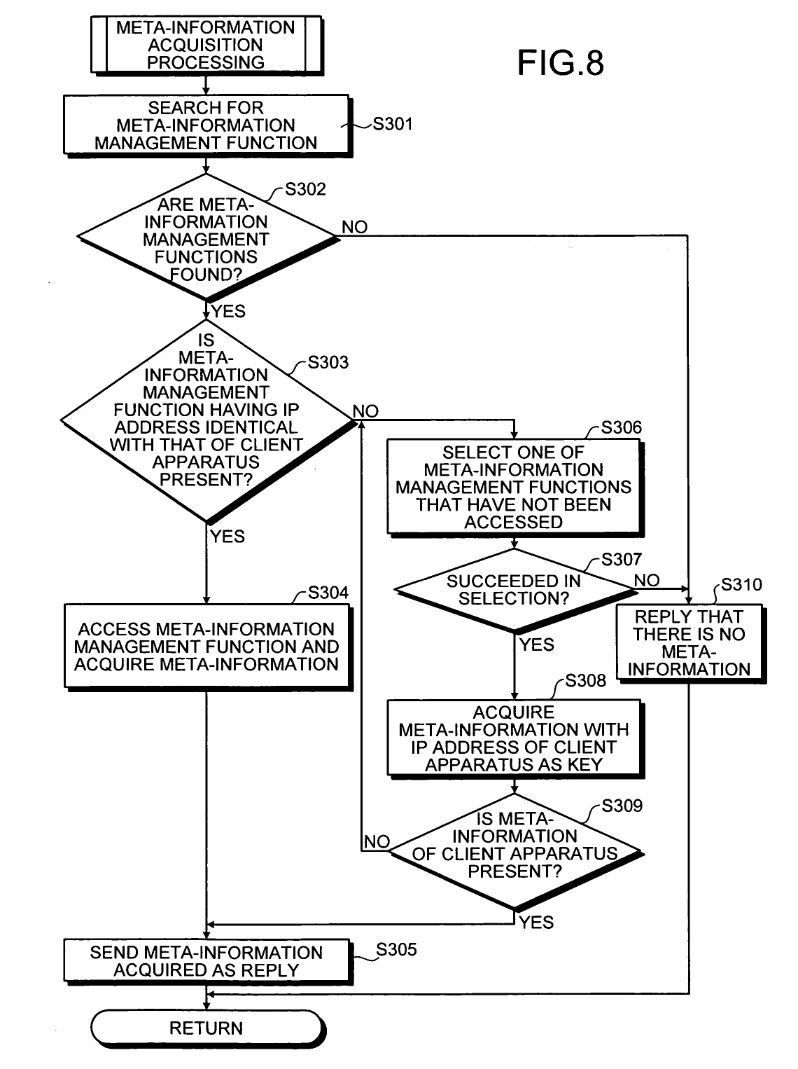

A processing procedure of the meta-information acquisition processing is explained. FIG. 8 is a flowchart of the processing procedure of the meta-information acquisition processing. As shown in the figure, in the meta-information acquisition processing, the access control unit 130 searches for meta-information management functions (step S301). Specifically, the access control unit 130 performs finding processing by multicast defined in the UPnP.

The access control unit 130 judges whether meta-information management functions are found (step S302). When meta-information management functions are found, the access control unit 130 judges whether a meta-information management function having an IP address identical with that of the client apparatus 10 requesting access is present (step S303).

As a result, when the meta-information management function having the IP address identical with that of the client apparatus 10 is present, the access control unit 130 accesses the meta-information management function and acquires meta-information (step S304). The access control unit 130 sends the meta-information acquired to the client apparatus 10 as a reply (step S305).

On the other hand, when the meta-information management function having the IP address identical with that of the client apparatus 10 is not present, the access control unit 10 selects one of meta-information management functions that have not been accessed (step S306). When the access control unit 130 has succeeded in the selection (“Yes” at step S307), the access control unit 130 acquires meta-information with the IP address of the client apparatus 10 as a key (step S308).

When meta-information of the client apparatus 10 is present (“Yes” at step S309), the access control unit 130 sends the meta-information acquired to the client apparatus 10 as a reply (step S305). When meta-information of the client apparatus 10 is not present (“No” at step S309), the access control unit 130 returns to step S306 and selects the next meta-information management function.

When the access control unit 130 has failed in the selection of a meta-information management function that has not been accessed (“No” at step S307) or when the access control unit 130 cannot find meta-information management functions (“No” at step S302), the access control unit 130 replies that there is no meta-information (step S310).

In this way, the access control unit 130 searches for a meta-information management function and acquires meta-information of the client apparatus 10 requesting a service. Consequently, it is possible to provide the approver with meta-information.

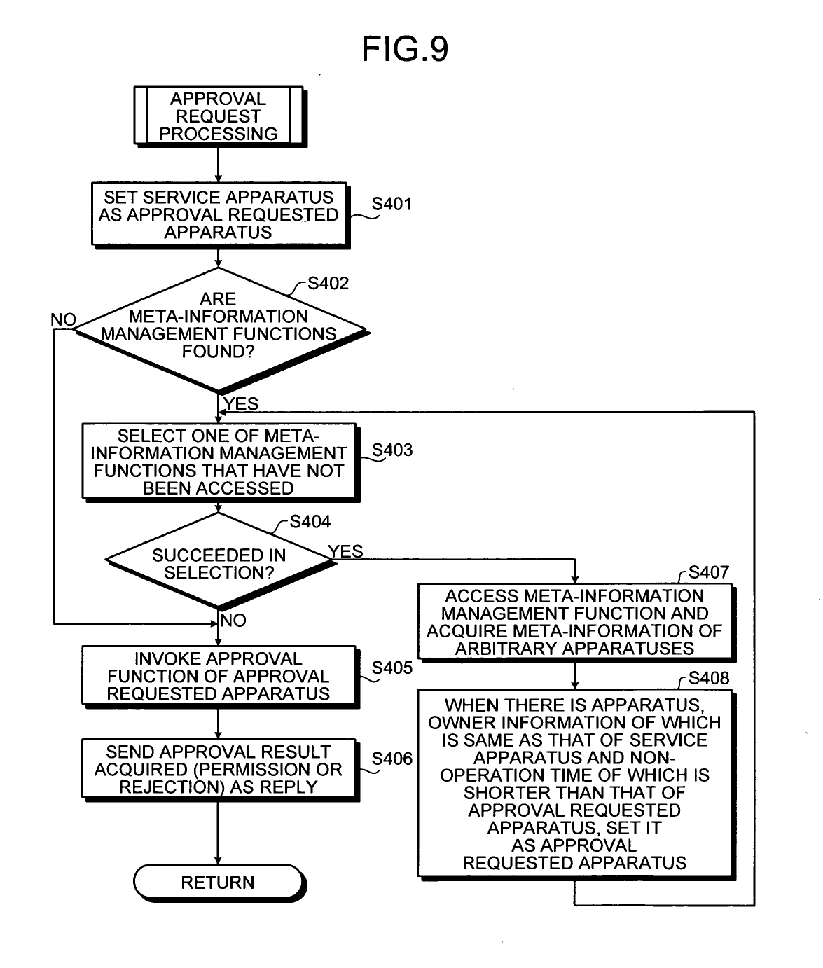

A processing procedure of the approval request processing is explained. FIG. 9 is a flowchart of the processing procedure of the approval request processing. As shown in the figure, in the approval request processing, first, the access control unit 130 sets the service apparatus 100 as an approval requested apparatus (step S401).

The access control unit 130 searches for meta-information management functions and judges whether meta-information management functions are found (step S402). As a result, when meta-information management functions are found, the access control unit 130 selects one of meta-information management functions that have not been accessed (step S403). When the access control unit 130 has failed in the selection (“No” at step S404), the access control unit 130 invokes an approval function of the service apparatus 100 (step S405). The access control unit 130 acquires an approval result (permission or rejection) from the service apparatus 100 and sends the approval result to the client apparatus 10 as a reply (step S406).

On the other hand, when the access control unit 130 has succeeded in the selection of a meta-information management function that has not been accessed (“Yes” at step S404), the access control unit 130 accesses the meta-information management function and acquires meta-information of arbitrary (all) apparatuses (step S407).

When there is an apparatus, owner information of which is the same as that of the service apparatus 100 and a non-operation time of which is shorter than that of the service apparatus 100, is present in the meta-information acquired, the access control unit 130 sets the apparatus as an approval requested apparatus (step S408). The access control unit 130 returns to step S403 and selects another meta-information management function.

In this way, the access control unit 130 acquires meta-information of the respective apparatuses and selects an apparatus, owner information of which is the same as that of the service apparatus 100 and a non-operation time of which is the shortest, as an approval requested apparatus. Consequently, it is possible to determine an apparatus considered to be most convenient for the approver as the approving apparatus 20.

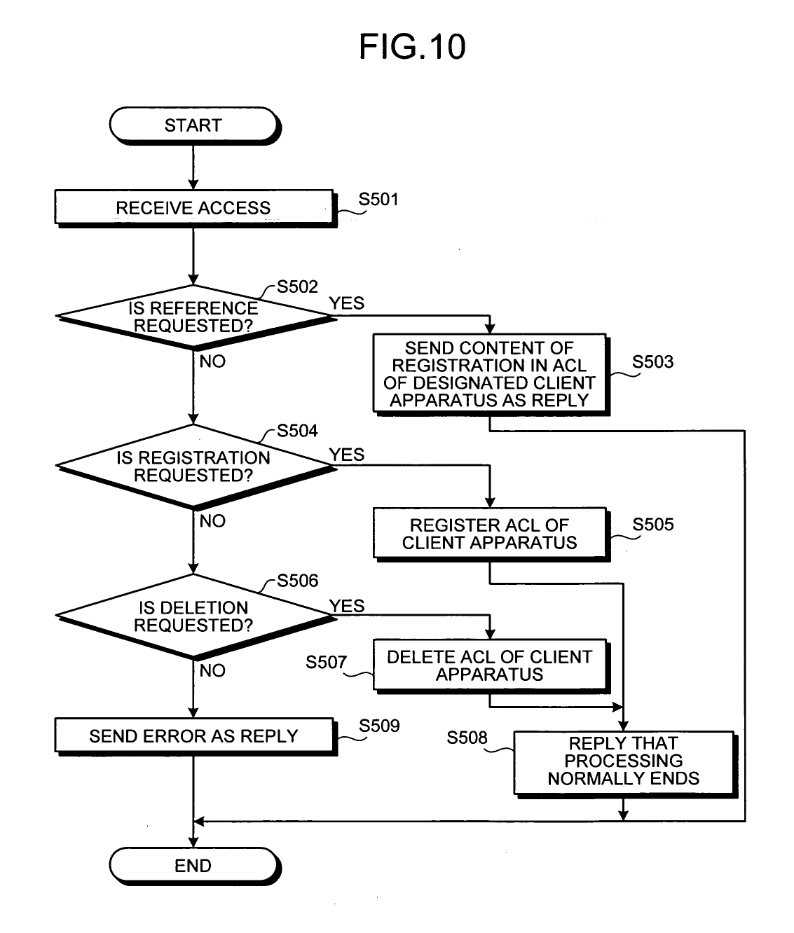

A processing procedure of the ACL managing unit 140 is explained. FIG. 10 is a flowchart of the processing procedure of the ACL managing unit 140. As shown in the figure, the ACL managing unit 140 receives access from the access control unit 130 (step S501) and judges whether the access is an ACL reference request (step S502).

As a result, when the access is the ACL reference request, the ACL managing unit 140 sends content of registration in an ACL of the client apparatus 10 designated to the access control unit 130 as a reply (step S503). When the access is not the ACL reference request, the ACL managing unit 140 judges whether the access is an ACL registration request (step S504).

As a result, when the access is the ACL registration request, the ACL managing unit 140 registers the ACL of the client apparatus 10 designated (step S505) and replies that the processing normally ends (step S508). On the other hand, when the access is not the ACL registration request, the ACL managing unit 140 judges whether the access is a deletion request (step S506).

As a result, when the access is the ACL deletion request, the ACL managing unit 140 deletes the ACL of the client apparatus 10 designated (step S507) and replies that the processing normally ends (step S508). On the other hand, when the access is not the ACL deletion request, the ACL managing unit 140 sends an error to the access control unit 130 as a reply (step S509).

In this way, the ACL managing unit 140 manages the ACL. Consequently, after a judgment of propriety of access is acquired from the approver once, it is possible to efficiently make a judgment processing for propriety of access.

A processing procedure of the meta-information managing unit 150 is explained. Although the processing procedure of the meta-information managing unit 150 of the service apparatus 100 is explained, the client apparatus 10 and the approving apparatus 20 perform processing with the same procedure.

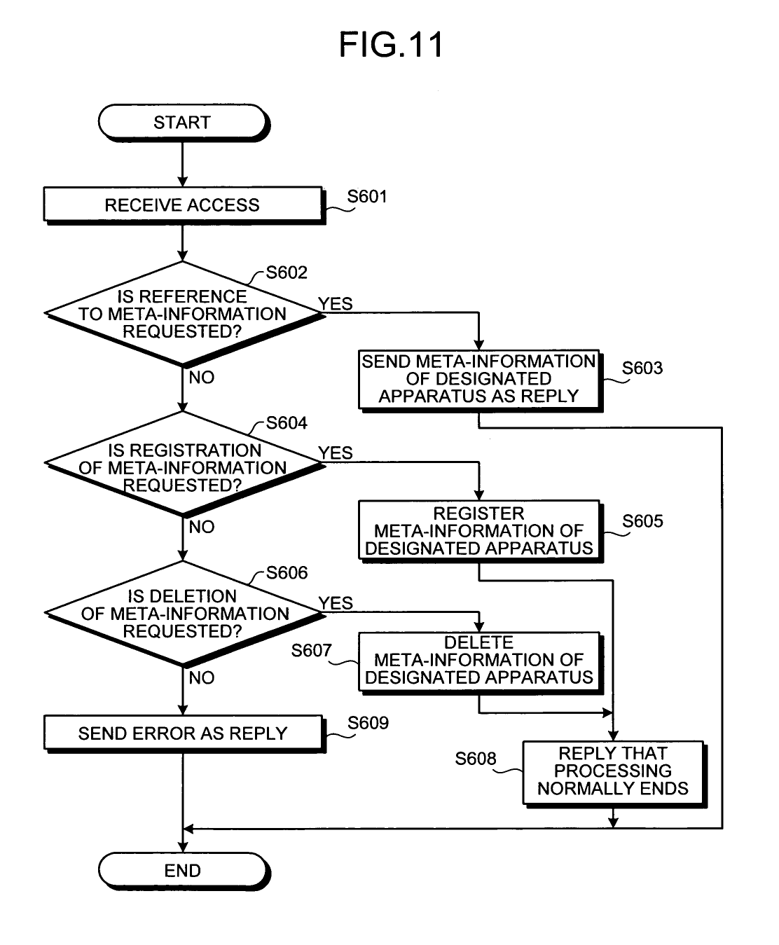

FIG. 11 is a flowchart of the processing procedure of the meta-information managing unit 150. As shown in the figure, when the meta-information managing unit 150 receives access (step S601), the meta-information managing unit 150 judges whether the access is a meta-information reference request (step S602).

As a result, when the access is the meta-information reference request, the meta-information managing unit 150 sends meta-information of a designated apparatus as a reply (step S603). When the access is not the meta-information reference request, the meta-information managing unit 150 judges whether the access is a meta-information registration request (step S604).

As a result, when the access is the meta-information registration request, the meta-information managing unit 150 registers the meta-information of the designated apparatus (step S605) and replies that the processing normally ends (step S608). On the other hand, when the access is not the meta-information registration request, the meta-information managing unit 150 judges whether the access is a meta-information deletion request (step S606).

As a result, when the access is the meta-information deletion request, the meta-information managing unit 150 deletes the meta-information of the designated apparatus (step S607) and replies that the processing normally ends (step S608). On the other hand, when the access is not the meta-information deletion request, the meta-information managing unit 150 sends an error as a reply (step S609).

In this way, the meta-information managing unit 150 manages the meta-information. Consequently, it is possible to provide the meta-information in response to meta-information acquisition requests by the other apparatuses.

A processing procedure of the approving unit 22 is explained. Although the processing procedure of the approving unit 22 of the approving apparatus 20 is explained, the approving unit 160 of the service apparatus 100 performs processing with the same procedure.

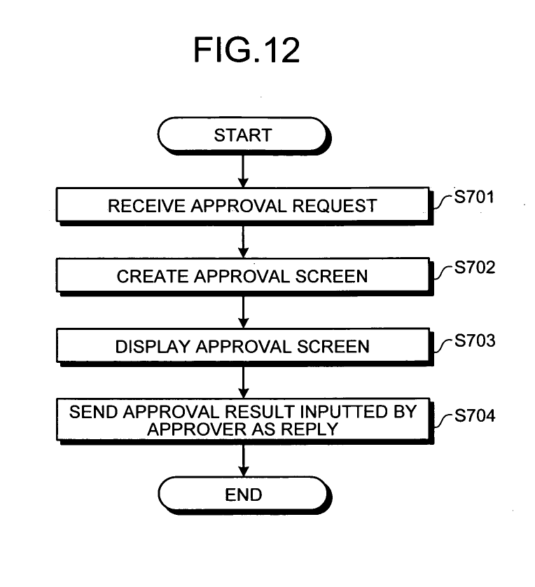

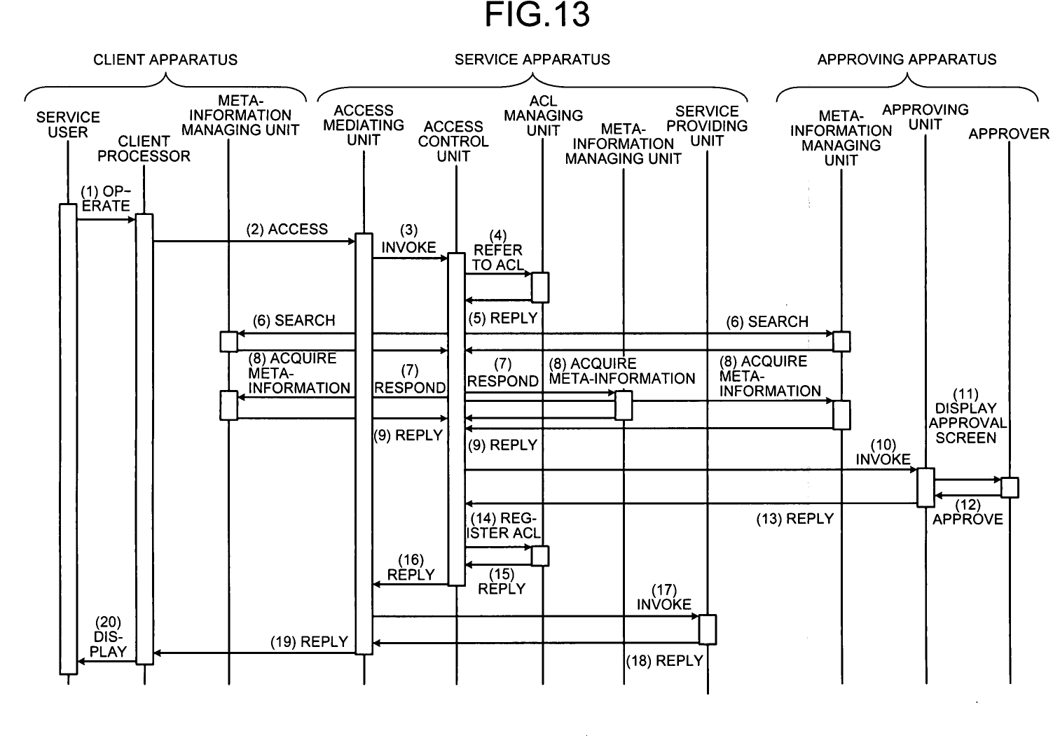

FIG. 12 is a flowchart of the processing procedure of the approving unit 22. As shown in the figure, the approving unit 22 receives an approval request from the access control unit 130 (step S701) and creates an approval screen based on meta-information and the like designated by the access control unit 130 (step S702).

The approving unit 22 displays the approval screen created (step S703) and sends an approval result inputted by the approver to the access control unit 130 as a reply (step S704).

In this way, the approving unit 22 creates the approval screen based on the meta-information and the like designated by the access control unit 130. Consequently, the approver can appropriately judge propriety of access.

An operation sequence of an access control system according to this embodiment is explained. FIG. 13 is a diagram of the operation sequence of the access control system according to this embodiment. As shown in the figure, in this access control system, the following processing is performed.

(1) The client processor 11 of the client apparatus 10 receives a service request operation by a service user.

(2) Although the client processor 11 accesses the service apparatus 100, the access is relayed by the access mediating unit 120 once.

(3) When the access mediating unit 120 receives the access, the access mediating unit 120 invokes the access control unit 130.

(4) The access control unit 130 invokes the ACL managing unit 140 and checks whether an access source is already registered in the ACL.

(5) The ACL managing unit 140 sends presence or absence of registration of the access source in the ACL and, if registered, sends access permission (or rejection) to the access control unit 130 as a reply. When permission or rejection is registered in the ACL, the ACL managing unit 140 informs the access control unit 130 of permission or rejection. When permission or rejection is not registered in the ACL, the ACL managing unit 140 performs the following processing. Since nothing is registered in the ACL in the beginning, the access control unit 130 proceeds to processing (6).

(6) The access control unit 130 searches for a meta-information management function using a service finding function of the UPnP.

(7) The meta-information managing units send presence of the client apparatus 10 and the approving apparatus 20 in response to a search request. As a result, the service apparatus 100 obtains addresses (URLs) for accessing meta-information management functions of the client apparatus 10 and the approving apparatus 20. When the access control unit 130 cannot find a meta-information managing function, the following processing (8) and (9) is not performed.

(8) The access control unit 130 requests the meta-information management functions found to send meta-information. Specifically, the access control unit 130 requests meta-information concerning the client apparatus 10 and, then, requests meta-information of the other apparatuses.

(9) The meta-information managing units of the apparatuses send the meta-information requested as replies. As a result, the access control unit 130 obtains the pieces of meta-information shown in FIGS. 3A to 3C. The access control unit 130 determines, using the meta-information acquired, a terminal that is requested to approve access. In other words, the access control unit 130 selects the approving apparatus 20, an owner of which is identical with that of the service apparatus 100 and has a non-operation time shorter than that of the service apparatus 100, as an approval requested apparatus.

(10) The access control unit 130 invokes an approving unit of a terminal that displays an approval screen. In other words, the access control unit 130 invokes the approving unit 22 of the approving apparatus 20.

(11) The approving unit 22 presents acquired meta-information (if acquired) to the approver in addition to a host name, an IP address, and the like of an access source and requests approval of access. An approval request screen displayed is, for example, as shown in FIG. 5.

(12) The approving unit 22 receives an approval result (permission or rejection) of access by the approver. It is assumed that depression of a permission button by the approver (B) is received.

(13) The approving unit 22 sends the approval result to the access control unit 130 as a reply. In other words, the approving unit 22 replies that the access is permitted.

(14) The access control unit 130 instructs the ACK managing unit 140 to register the approval result. In other words, the ACK managing unit 140 registers a set of an IP address (192.168.1.101) and an approval result (permission). The ACL after execution is as shown in FIG. 4.

(15) The ACL managing unit 140 replies that the registration is completed.

(16) The access control unit 130 sends the approval result of the user, that is, permission, as a reply. When the approval result is rejection, the access mediating unit 120 sends an error in response to the access from the client apparatus 10.

(17) When the approval result is permission, the access mediating unit 120 relays the access to the service providing unit 110.

(18) The service providing unit 110 sends a processing result to the access mediating unit 120 as a reply.

(19) The access mediating unit 120 transfers the reply from the service providing unit 110.

(20) The client processor 11 displays the processing result obtained for the user.

As described above, in this embodiment, when the access mediating unit 120 of the service apparatus 100 receives a service request from the client apparatus 10, the access mediating unit 120 inquires the access control unit 130 about access propriety. The access control unit 130 refers to the ACL via the ACL managing unit 140. When the client apparatus 10 is not registered in the ACL, the access control unit 130 acquires meta-information of the client apparatus 10 and meta-information of the other apparatuses in cooperation with the meta-information managing units of the respective apparatuses. The access control unit 130 determines the approving apparatus 20 based on the meta-information acquired. The access control unit 130 causes the approving apparatus 20 determined to display the meta-information of the client apparatus 10 and requests the approver to judge propriety of service provision. Thus, the approver can obtain a lot of useful information on the client apparatus 10 as meta-information and accurately judge propriety of service provision.

In the explanation of this embodiment, the service apparatus 100 includes the access mediating unit 120, the access control unit 130, and the ACL managing unit 140. However, the present invention is not limited to this. It is also possible to apply the present invention to another apparatus serving as an access control apparatus includes these functional units.

In this embodiment, security issues such as authentication of apparatuses, encryption of communication, and reliability of meta-information are not referred to. However, it is possible to combine the access control system with the existing security technology as required. For example, it is possible to use, as the authentication of apparatuses, a method based on the Public Key Infrastructure (PKI) for allocating a key created by the public key encryption method to each of apparatuses. It is possible to apply the encryption communication technology such as Secure Socket Layer (SSL) to the encryption of communication. It is possible to use the technology such as an electronic signature to assure reliability of meta-information.

In the explanation of this embodiment, the client apparatus, the service apparatus, and the approving apparatus are explained. However, it is possible to obtain a client program, a service program, and an approving program having the same functions as the apparatuses by realizing the constitutions of the apparatuses using software. Thus, as an example, a computer that executes an access control program for realizing the functions of the access mediating unit 120, the access control unit 130, and the ACL managing unit 140 as a part of a service program is explained.

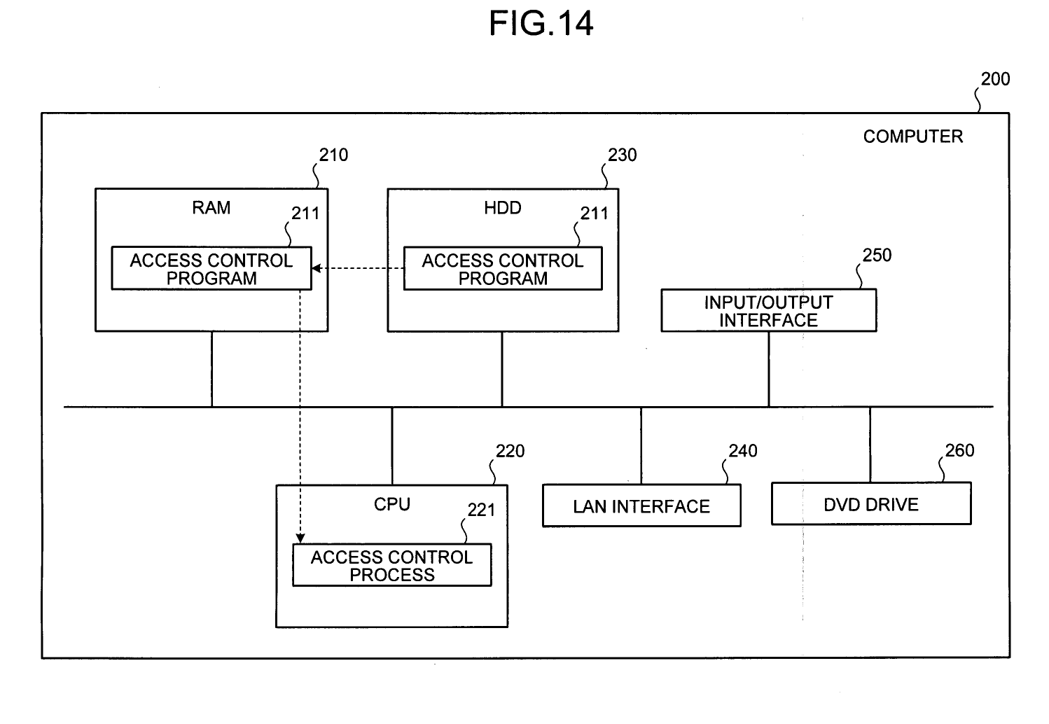

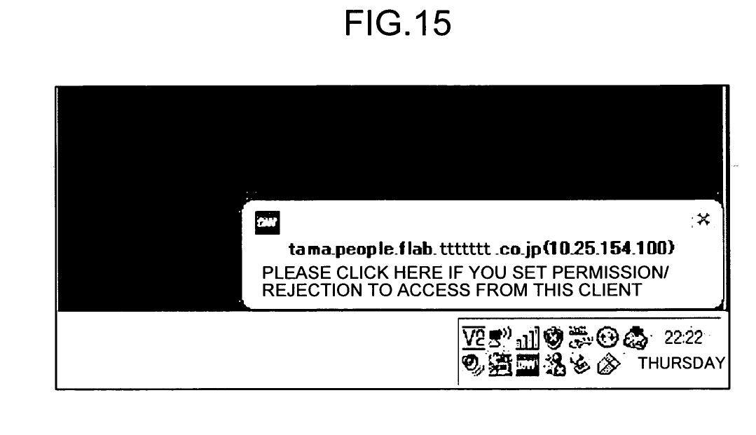

FIG. 14 is a functional block diagram of a constitution of a computer that executes an access control program according to the present embodiment. As shown in the figure, a computer 200 includes a Random Access Memory (RAM) 210, a Central Processor (CPU) 220, a Hard Disk Drive (HDD) 230, a Local Area Network (LAN) interface 240, an input/output interface 250, and a Digital Versatile Disk (DVD) drive 260.

The RAM 210 is a memory that stores a program and a result during execution of the program. The CPU 220 is a central processor that reads out the program from the RAM 210 and executes the program.

The HDD 230 is a disk device that stores a program and data. The LAN interface 240 is an interface for connecting the computer 200 to other computers through a LAN.

The input/output interface 250 is an interface for connecting input devices such as a mouse and a keyboard and a display device. The DVD drive 260 is a device that reads data from and writes data in a DVD.

An access control program 211 executed in the computer 200 is stored in the DVD, read out from the DVD by the DVD drive 260, and installed in the computer 200.

Alternatively, the access control program 211 is stored in databases or the like of other computer systems connected to the computer 200 via the LAN interface 240 and read out from the databases and installed in the computer 200.

The access control program 211 installed is stored in the HDD 230, read out to the RAM 210, and executed as an access control process 221 by the CPU 220.

It is possible to adopt various forms described below as a method of realizing the access mediating unit 120:

1. A platform library that operates subordinately to the service providing unit 110.

2. A personal firewall that operates in a machine that is the same as a machine in which as the service providing unit 110 is provided.

3. A gateway apparatus that is located between the client apparatus 10 and the service providing unit 110 and relays communication.

In the explanation of the present embodiment, the UPnP is used as the apparatus finding and cooperation protocol. However, the present invention is not limited to this. It is also possible to apply the present invention to access control systems that use other apparatus finding and cooperation protocols.

According to an embodiment of the present invention, the approver can judge propriety of access based on the requesting apparatus meta-information. Thus, there is an effect that it is possible to make an accurate judgment.

Moreover, there is an effect that it is possible to acquire the requesting apparatus meta-information even for an apparatus that is temporarily connected to the network and provide the approver with the requesting apparatus meta-information.

Furthermore, since the requesting apparatus meta-information is efficiently acquired, there is an effect that it is possible to efficiently perform processing for access control.

Moreover, since an approval requested apparatus is appropriately determined based on the candidate apparatus meta-information, there is an effect that it is possible to determine an apparatus convenient for the approver as the approval requested apparatus by appropriately setting the candidate apparatus meta-information.

Furthermore, since an apparatus owned by the approver is determined as the approval requested apparatus, it is possible to surely request the approver to approve access.

Moreover, since an apparatus, in front of which the approver is highly likely present, is determined as the approval requested apparatus, there is an effect that it is possible to increase possibility that a judgment on propriety of access is obtained from the approver.

Furthermore, since the approval requested apparatus is surely determined, there is an effect that it is possible to surely request an approval.

Moreover, since propriety of access is efficiently acquired, there is an effect that it is possible to efficiently perform processing for access control.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program that causes a computer to control access to a service in response to a service provision request from a client apparatus connected to the access control apparatus via a network, the computer program causing the computer to execute:
first acquiring including acquiring requesting apparatus meta-information that is meta-information of the client apparatus;
providing an apparatus used by an approver of access to the service for approval with the requiring apparatus meta-information acquired at the first acquiring and second acquiring including acquiring access propriety that is received by the apparatus from the approver by providing the approver with the requesting apparatus meta-information; and
controlling access to the service based on the access propriety acquired at the second acquiring.

2. The computer-readable recording medium according to claim 1, wherein the first acquiring includes
searching for a meta-information management function in apparatuses connected to the access control apparatus via the network; and
accessing, when the meta-information management function is found at the searching, the meta-information management function found and third acquiring including acquiring the requesting apparatus meta-information.

3. The computer-readable recording medium according to claim 2, wherein the accessing includes preferentially accesses the meta-information management function provided by the client apparatus and the third acquiring includes acquiring the requesting apparatus meta-information.

4. The computer-readable recording medium according to claim 1, wherein the providing includes
searching for a meta-information management function in apparatuses connected to the access control apparatus via the network;
accessing, when the meta-information management function is found at the searching, the meta-information management function found and a fourth acquiring including acquiring meta-information of the apparatuses provided by the meta-information management function as candidate apparatus meta-information;
determining, based on the candidate apparatus meta-information acquired at the fourth acquiring, an approval requested apparatus that provides the access approver with the requesting apparatus meta-information; and
providing the approval requested apparatus determined at the determining with the requesting apparatus meta-information and a fifth acquiring including acquiring the access propriety.

5. The computer-readable recording medium according to claim 4, wherein the candidate apparatus meta-information includes information on owners of the apparatuses, and
the determining includes determining one of the apparatuses owned by the same owner as an apparatus that provides the service as the approval requested apparatus.

6. The computer-readable recording medium according to claim 5, wherein the candidate apparatus meta-information includes information on non-operation times of the apparatuses, and
the determining includes determining, an apparatus, the non-operation time of which is shortest, among apparatuses owned by the same owner as an apparatus that provides the service, as the approval requested apparatus.

7. The computer-readable recording medium according to claim 4, wherein the candidate apparatus meta-information includes information on owners of the apparatuses, and
the determining includes determining, when there is no apparatus owned by the same owner as an apparatus that provides the service, the apparatus that provides the service as the approval requested apparatus.

8. The computer-readable recording medium according to claim 1, wherein the computer program further causes the computer to execute:
creating an access control list for the client apparatus based on access propriety acquired at the first acquiring and registering created access control list in a list of access control lists; and
searching through the list of access control lists in which the access control list is registered at the registering and, when the access control list for the client apparatus is found, a fifth acquiring including acquiring access propriety using the access control list found.

9. The computer-readable recording medium according to claim 1, wherein the searching includes searching a meta-information management function based on finding processing by multicast defined in UPnP.

10. An access control method of controlling access to a service in response to a service provision request from a client apparatus connected to the access control apparatus via a network, the access control method comprising:
first acquiring including acquiring requesting apparatus meta-information that is meta-information of the client apparatus;
providing an apparatus used by an approver of access to the service for approval with the requiring apparatus meta-information acquired at the first acquiring and second acquiring including acquiring access propriety that is received by the apparatus from the approver by providing the approver with the requesting apparatus meta-information; and
controlling access to the service based on the access propriety acquired at the second acquiring.

11. The access control method according to claim 10, wherein the first acquiring includes
searching for a meta-information management function in apparatuses connected to the access control apparatus via the network; and
accessing, when the meta-information management function is found at the searching, the meta-information management function found and third acquiring including acquiring the requesting apparatus meta-information.

12. The access control method according to claim 11, wherein the accessing includes preferentially accesses the meta-information management function provided by the client apparatus and the third acquiring includes acquiring the requesting apparatus meta-information.

13. The access control method according to claim 10, wherein the providing includes
searching for a meta-information management function in apparatuses connected to the access control apparatus via the network;
accessing, when the meta-information management function is found at the searching, the meta-information management function found and a fourth acquiring including acquiring meta-information of the apparatuses provided by the meta-information management function as candidate apparatus meta-information;
determining, based on the candidate apparatus meta-information acquired at the fourth acquiring, an approval requested apparatus that provides the access approver with the requesting apparatus meta-information; and
providing the approval requested apparatus determined at the determining with the requesting apparatus meta-information and a fifth acquiring including acquiring the access propriety.

14. The access control method according to claim 13, wherein the candidate apparatus meta-information includes information on owners of the apparatuses, and
the determining includes determining one of the apparatuses owned by the same owner as an apparatus that provides the service as the approval requested apparatus.

15. An access control apparatus that controls access to a service in response to a service provision request from a client apparatus connected to the access control apparatus via a network, the access control apparatus comprising:
a meta-information acquiring unit that acquires requesting apparatus meta-information that is meta-information of the client apparatus;
an access propriety acquiring unit that provides an apparatus used by an approver of access to the service for approval with the requiring apparatus meta-information acquired by the meta-information acquiring unit and acquires access propriety that is received by the apparatus from the approver by providing the approver with the requesting apparatus meta-information; and
a service provision control unit that controls access to the service based on the access propriety acquired by the access propriety acquiring unit.

16. The access control apparatus according to claim 15, wherein the meta-information acquiring unit includes
a finding processor that searches for a meta-information management function in apparatuses connected to the access control apparatus via the network; and
a requesting apparatus meta-information acquiring unit that accesses, when the meta-information management function is found by the finding processor, the meta-information management function found and acquires the requesting apparatus meta-information.

17. The access control apparatus according to claim 16, wherein the requesting apparatus meta-information acquiring unit preferentially accesses the meta-information management function provided by the client apparatus and acquires the requesting apparatus meta-information.

18. The access control apparatus according to claim 15, wherein the access propriety acquiring unit includes
a finding processor that searches for a meta-information management function in apparatuses connected to the access control apparatus via the network;
a candidate apparatus meta-information acquiring unit that accesses, when the meta-information management function is found by the finding processor, the meta-information management function found and acquires meta-information of the apparatuses provided by the meta-information management function as candidate apparatus meta-information;
an approval requested apparatus determining unit that determines, based on the candidate apparatus meta-information acquired by the candidate apparatus meta-information acquiring unit, an approval requested apparatus that provides the access approver with the requesting apparatus meta-information; and
a requesting unit that provides the approval requested apparatus determined by the approval requested apparatus determining unit with the requesting apparatus meta-information and acquires the access propriety.

19. The access control apparatus according to claim 18, wherein the candidate apparatus meta-information includes information on owners of the apparatuses, and
the approval requested apparatus determining unit determines one of the apparatuses owned by the same owner as an apparatus that provides the service as the approval requested apparatus.
